(19) United States
(12) Patent Application Publication
(10) Pub. No.: US 2011/0182367 A1
(43) Pub. Date: Jul. 28, 2011

(54) MEDIA CODING APPARATUS AND MEDIA CODING METHOD

(76) Inventor: Yuji Kawashima, Tokyo (JP)

(21) Appl. No.: 12/981,166

(22) Filed: Dec. 29, 2010

(30) Foreign Application Priority Data
Jan. 28, 2010 (JP) 2010-016228

(51) Int. Cl. H04N 7/26

(52) U.S. Cl. 375/240.28; 375/E07.076

(57) ABSTRACT

According to one embodiment, a media coding apparatus is provided. The media coding apparatus includes: a coding module which codes each of a plurality of input media; and a multiplexing module which multiplexes a plurality of coded media so as to synchronize replays of the plurality of coded media with each other. The multiplexing module inserts dummy data into a media whose head timing has a delay among the plurality of coded media, the dummy data having a time length that is equal to the delay.

### CROSS REFERENCE TO RELATED APPLICATION(S)

The application is based upon and claims the benefit of priority from Japanese Patent Application No. 2010-016228 filed on Jan. 28, 2010; the entire contents of which are incorporated herein by reference.

### FIELD

Embodiments described herein relate generally to a media coding apparatus and media coding method.

### BACKGROUND

In recent years, composite content files in which plural kinds of media such as video data, audio data, and text data are multiplexed together are used for content distribution services for portable terminals, streaming broadcast, etc. One of file formats of such composite content files is a MP4 file format that is prescribed in Part 14 of the ISO/IEC 14496 standard (hereinafter referred to as the MP4 file format).

However, as described below, the MP4 file format has basically sync loss that results from time stamps. According to the MP4 file format, first, plural kinds of media such as video data and audio data are multiplexed as plural tracks. Each track has units called samples which correspond to frames of the video data or the audio data. Each sample contains such pieces of information as a time stamp and a data length which are coded according to certain methods. Time stamps are coded in such a manner that differences between time stamp values of successive samples rather than time stamp values themselves of individual samples are coded. The time stamp of the head sample is dealt with as having a value “0.” Therefore, if tracks whose head samples have different time stamps are multiplexed into an MP4 file as they are, synchronization will be lost when the data are replayed.

In one countermeasure against the sync loss problem, when MP4 file division or extraction is performed in a stream edit, the time stamps of the head samples of respective tracks of a resulting stream are held using a data format of its own (refer to JP-A-2008-153886). However, since the technique of JP-A-2008-153886 employs its own data format, players cannot replay in a desired manner (i.e., sync loss occurs) unless the players can interpret time stamps having that data format. In these circumstances, a countermeasure is desired which allows players that comply with the MP4 standard to replay, in a desired manner, data generated by a multiplexing method that complies with the MP4 standard.

### BRIEF DESCRIPTION OF THE DRAWINGS

FIG. 1 is a view showing a general configuration of a multimedia file processing system according to an embodiment.

FIG. 2 is a block diagram showing an apparatus according to the embodiment.

FIG. 3 is a view showing a video stream and an audio stream having different replay start times.

FIGS. 4A and 4B are views showing a multimedia multiplexing method according to the embodiment.

FIG. 5 is a view showing an example MP4 file format used in the embodiment.

### DETAILED DESCRIPTION

In general, according to one embodiment, According to one embodiment, a media coding apparatus is provided. The media coding apparatus includes: a coding module which codes each of a plurality of input media; and a multiplexing module which multiplexes a plurality of coded media so as to synchronize replays of the plurality of coded media with each other.

The multiplexing module inserts dummy data into a media whose head timing has a delay among the plurality of coded media, the dummy data having a time length that is equal to the delay.

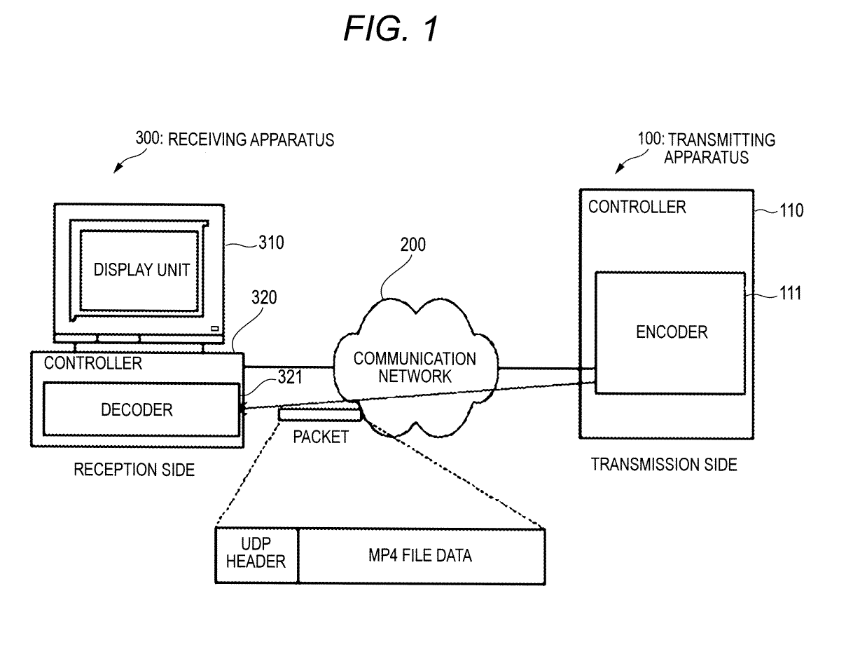

An embodiment will be hereinafter described with reference to FIGS. 1 to 5.

FIG. 1 is a view showing a general configuration of a multimedia file processing system according to the embodiment. As shown in FIG. 1, the system includes a transmitting apparatus 100 which sends video data having the MP4 file format, a communication network 200 including an exchange station, and a receiving apparatus 300 which receives video data transmitted from the transmitting apparatus 100, replays and displays a resulting video on a display unit or the like.

The transmitting apparatus 100 has a controller 110 including at least an encoder 111. The transmitting apparatus 100 encodes, into MP4 file format data, video data having plural visible tracks (a video track, a text track, etc. that can be displayed visibly) in a presentation, inserts the video data into communication packets (e.g., packets according to user datagram protocol (UDP)), and sends out resulting packets to the communication network 200. A real-time transport protocol (RTP) may be employed as a higher-level protocol of UDP or the like.

For example, the transmitting apparatus 100 is a server and the encoder 111 is formed by hardware, software, etc. The transmitting apparatus 100 may be configured so as to separate a signal to be encoded from a broadcast signal that is selected by an internal or external tuner (not shown). The transmitting apparatus 100 may be such as to execute further steps of recording and replaying the signal before the separation.

The receiving apparatus 300 has a controller 320 including at least a decoder 321. The receiving apparatus 300 extracts MP4 file format data from packets received from the transmitting apparatus 100 via the communication network 200 and displays a presentation of a video or the like on a display unit 310 based on the extracted MP4 file format data.

For example, the receiving apparatus 300 is a personal computer (PC) or a portable terminal and the decoder 321 is formed by hardware, software, etc.

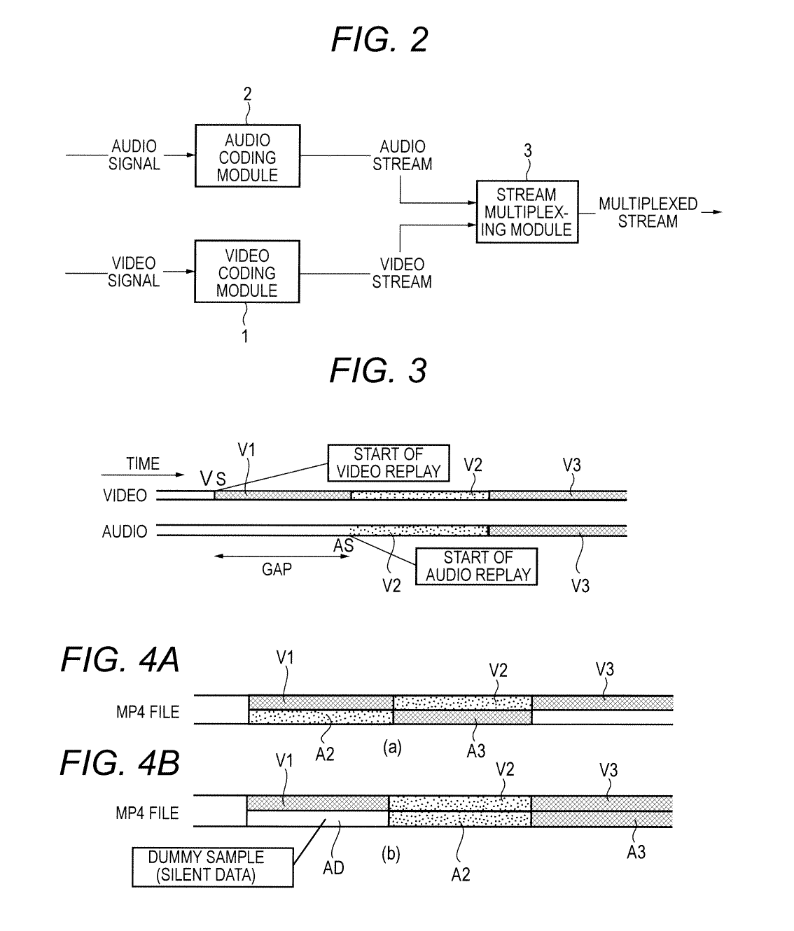

FIG. 2 is a block diagram showing an apparatus according to the embodiment. FIG. 2 is a functional block diagram of an apparatus which corresponds to the encoder 111 shown in FIG. 1, and the apparatus includes a video coding module 1, an audio coding module 2, and a stream multiplexing module 3.

The video coding module 1 encodes an input video signal into a video stream according to a certain video coding method, and outputs the video stream to the stream multiplexing module 3.

The audio coding module 2 encodes an input audio signal into an audio stream according to a certain audio coding method, and outputs the audio stream to the stream multiplexing module 3.

The stream multiplexing module 3 converts the received video stream and audio stream into a multiplexed stream having the MP4 file format, and outputs the multiplexed stream. The stream multiplexing module 3 is configured so as to perform multiplexing processing with insertion of dummy samples (described later).

In the MP4 system layer, plural kinds of media exist in mixture and a header containing such information as media replaying conditions and a media data containing only a media stream are provided. In this respect, the MP4 system layer is different from the system layers of MPEG-2, PS, and TS.

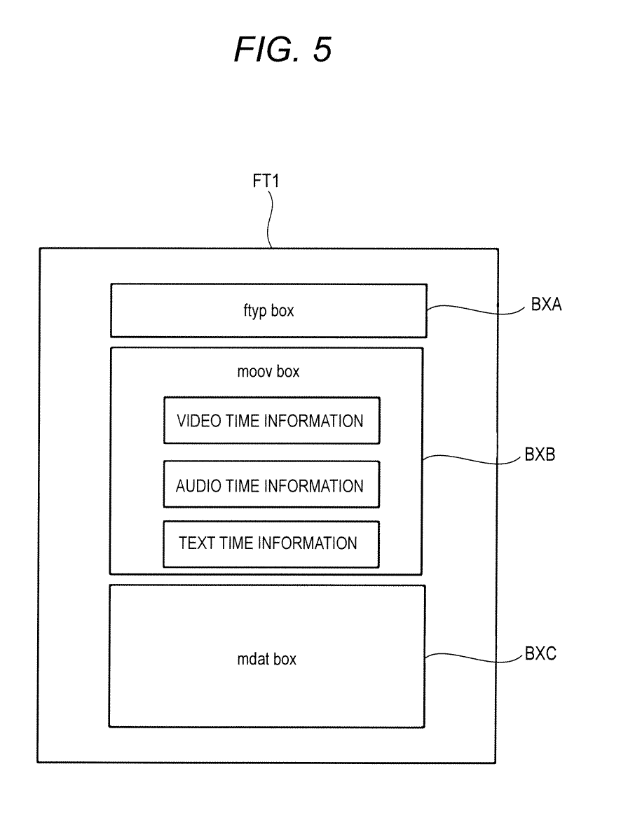

FIG. 5 is a view showing a conventional MP4 file format FT1. In general, the box structure of an MP4-based media file format is a tree structure. Main boxes are as follows.

Only one file type description “ftyp box” (file type box BXA) is provided in a file at its head.

A “moov box” BXB is a container which contains all metadata, and a file contains only one moov box BXB. Example pieces of data that are contained as metadata are header information of each track (video, audio, or the like), a meta description of details of a content, and time information.

A media data box “mdat box” BXC is a container of a media data body (bodies) of a track(s). The number of media data boxes BXC provided in a file is arbitrary. And a file may have tracks in an arbitrary manner. For example, a file may have only a video track, only an audio track, or plural kinds of tracks such as a video track and an audio track.

The file type box BXA of the MP4 file format FT1 shown in FIG. 5 contains information indicating compatibility of the file. The moov box BXB which is a header contains, information, relating to replaying conditions of each media data contained in the media data box BXC, pieces of position information of media data frames, time information (mentioned above), size information, etc. Each media data box BXC contains media data such as video data, audio data, or text data.

In general, it is recommended that compressed video data and compressed audio data be arranged alternately (interleaving) in a media data box BXC. For example, if there are one kind of video data and one kind of audio data, the video data and audio data are not arranged in such a manner that the video data are arranged continuously first and then the audio data are arranged continuously. However, this configuration will not be described in detail because it is not related to the invention closely. In the example of FIG. 5, the moov box BXB (header) is located before the media data box BXC. However, whereas the standard dictates that the file type box BXA should be located at the head of a file (mentioned above), the moov box BXB and the media data box BXC may be arranged in any order. Since the contents of the moov box BXB can be determined only after determination of the media data box BXC, the moov box BXB may be located after the media data box BXC.

There are independent pieces of box information and interrelated pieces of box information. For example, boundary positions between video data and audio data in the media data box BXC are not determined from only the data in the media data box BXC. Although the internal structure of the media data box BXC will not be described below in detail, it is necessary to refer to the contents of “stsc” box and “stco” box. The decoder 321 also refers to the contents of “stsz” box and recognizes data positions and sizes of respective frames from those three kinds of box information.

To synchronize video data and audio data during replaying, the decoder 321 acquires replaying times and time points of respective video frames and audio frames (storage units) by referring to “stts” box. Data whose replaying time varies from one frame to another (i.e., variable-frame-rate data) can be generated by using the “stts” box properly.

The ftyp box BXA (file type description) which is shown at the top in FIG. 5 contains information indicating compatibility of the file. The MP4 file has flexible format and a wide variety of video/audio data are contained in MP4 files. The information indicating compatibility of the file is used for assigning optimum players (decoders) and replaying methods to respective data in the case where plural types of data exist in mixture.

Since the MP4 file format is a format for containing data into a file, the MP4 file format itself is said to be not suitable for streaming delivery. In general, to deliver an MP4 file by streaming, it is converted into a file having the RTP (real-time transport protocol) format or the like. Such standards as

RTP prescribe a hint track as option information for facilitating conversion into a streaming format in delivering an MP4 file by streaming. The hint track for RTP delivery contains such information as an RPT header.

According to the MP4 file format, a file contains, as time information, replaying time lengths, rather than replaying time points, of respective media frames. That is, a file contains, as time information, such pieces of information as “the first frame of the video data should be replayed for certain ms” and “the second frame of the video data should be replayed for certain ms.” Therefore, video is replayed according to replaying time lengths of video data and audio is replayed according to replaying time lengths of audio data, and the two kinds of data need to be synchronized with each other during replaying by a separate measure.

For example, the user of a portable terminal can replay a composite content file having the MP4 file format delivered and received by his or her own portable terminal.

In MP4 multiplexing processing, plural kinds of media such as video data and audio data are multiplexed as tracks. However, the MP4 multiplexing has a basic problem of sync loss that results from time stamps. That is, if plural tracks whose head data (head samples) have different time stamps are merely multiplexed into an MP4 file without taking any proper measure as the one according to the embodiment, sync loss will occur when the tracks are replayed.

FIG. 3 is a view showing a video stream and an audio stream having different replay start times. FIGS. 4A and 4B are views showing a multimedia multiplexing method according to the embodiment.

Each track has data units called samples which correspond to frames of video data or audio data. Each sample contains such pieces of information as a time stamp and a data length which are coded according to certain methods. Time stamps are coded in such a manner that differences between time stamp values of successive samples rather than time stamp values themselves of individual samples are coded. The time stamp of the head sample is dealt with as having a value “0.” Therefore, if tracks whose head samples have different time stamps having a gap (AS-VS) (see FIG. 3) are multiplexed into an MP4 file as they are, synchronization will be lost when the tracks are replayed (see FIG. 4A). In the example of FIG. 4A, the video stream has intervals V1, V2, and V3 which are arranged in this order in the time axis and the audio stream has intervals A2 and A3 which are arranged in this order in the time axis. Although the intervals V2 and V3 of the video stream have the same replaying times as the intervals A2 and A3 of the audio stream, respectively, the head samples of the video stream and the audio stream have different time stamps.

In the embodiment, as shown in FIG. 4B, when tracks whose head samples have different time stamps are multiplexed together, multiplexing is performed after equalizing the time stamps of the head samples of the video stream and the audio stream by inserting dummy samples in the track whose head sample has a later time stamp.

Where the head samples (frames) of an input video stream and an input audio stream have different time stamps, multiplexing is performed after equalizing the time stamps of the head samples of the video stream and the audio stream by inserting a dummy sample in the track whose head sample has a later time stamp and setting the time stamp of the dummy sample equal to the time stamp of the head sample of the track whose head sample has an earlier time stamp. In the example of FIG. 4B, the audio stream is a later track and a dummy sample AD is inserted in the audio track. The time length of the dummy sample AD is set equal to the gap (AS-VS) shown in FIG. 3. In general, where there are plural later tracks, dummy samples having respective proper time lengths are generated and inserted.

A dummy sample that is inserted in the above manner may be a sample that can be generated even without the video coding module 1 and the audio coding module 2.

In the case of a video stream, a single-color frame or a fade-in image for the head frame may be used as a dummy sample. Where the video coding method is H.264/AVC and frames are ones coded only by intra DC prediction, a gray frame (or a black frame, etc.) can be generated and used as a dummy sample. A fade-in image can be generated by making the head frame a reference frame and using weighted prediction. In the case of an audio stream, a silent frame is suitably used as a dummy sample.

Such coded data may be held in the stream multiplexing module 3 in advance and inserted selectively as a dummy sample for respective cases. Although the embodiment is directed to only the case of multiplexing video data and audio data together, the same concept applies to the case of multiplexing that involves still image data or text data such as subtitle data or character data.

The embodiment provides an advantage that an MP4 stream having plural tracks can be replayed in such a manner that the plural tracks are synchronized with each other, without the need for using information other than the MP4 stream. The above description is summarized as follows.

### <Background and Problem>

MP4 is a recording format for multimedia. MP4 makes it possible to multiplex together, as tracks, plural media such as video data and audio data. Each track has data units called samples that correspond to frames of video data or audio data.

Each sample contains such pieces of information as a time stamp and a data length which are coded according to certain methods. Time stamps are coded in such a manner that differences between time stamp values of successive samples rather than time stamp values themselves of individual samples are coded. The time stamp of the head sample is dealt with as having a value “0.”

Therefore, if tracks whose head samples have different time stamps are multiplexed into an MP4 file as they are, synchronization will be lost when the tracks are replayed.

### <Means for Solution>

A dummy sample is inserted as a head frame of a track.

The dummy sample should be such as not to cause a replaying failure. Examples of the dummy sample may be a black frame (for video data), a silent frame (for audio data), and fade-in data for the head sample of a track.

### <Advantages>

A content having plural synchronized tracks can be replayed using only an MP4 stream. An MP4 stream generated according to the embodiment can be replayed by players that comply with the MP4 standard.

The embodiment provides an advantage that an MP4 stream having plural tracks can be replayed in such a manner that the plural tracks are synchronized with each other, without the need for using information other than the MP4 stream.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A media coding apparatus comprising:
a coding module configured to code each of a plurality of input media; and
a multiplexing module configured to multiplex a plurality of coded media so as to synchronize replays of the plurality of coded media with each other,
wherein the multiplexing module is configured to insert dummy data into a media whose head timing has a delay among the plurality of coded media, the dummy data having a time length that is equal to the delay.

2. The apparatus of claim 1, wherein the multiplexing module is configured to multiplex the plurality of coded media according to an MP4 file format which is the ISO/IEC 14496 Part 14.

3. The apparatus of claim 1, wherein the coding module is configured to code video according to H.264/AVC when the coding module serves as a video coding module.

4. The apparatus of claim 1 further comprising:
a tuner configured to receive broadcast signals and tuning into one of the received broadcast signals, wherein
an output of the tuner is used as the plurality of input media.

5. A media coding method comprising:
coding each of a plurality of input media;
inserting dummy data into a media whose head timing has a delay among a plurality of coded media, the dummy data having a time length that is equal to the delay; and
multiplexing the plurality of coded media so as to synchronize replays of the plurality of coded media with each other.
